(19) United States
(12) Patent Application Publication
(10) Pub. No.: US 2018/0201874 A1
(43) Pub. Date: Jul. 19, 2018

(54) CANDLE WITH A PRINTED OBJECT

(71) Applicant: Byung Eun MIN, Seoul (KR)

(72) Inventor: Byung Eun MIN, Seoul (KR)

(21) Appl. No.: 15/406,612

(22) Filed: Jan. 13, 2017

(51) Int. Cl. C11C 5/00

(52) U.S. Cl. CPC C11C 5/008

(57) ABSTRACT

A candle including a mass of opaque fuel and a wick extending therethrough is disclosed. A printed object is embedded in the mass of opaque fuel, wherein the printed object includes a plastic material having ink disposed thereon to depict an image.

### BACKGROUND

The inventive concept disclosed herein relates to candles, and particularly to candles that reveal an embedded object in response to heat.

There are many decorative candles in the market today, and candles make popular gifts for consumers of all ages. Candles come in many varieties, including scented or unscented, plain or with decorative visual objects. Some of the visual objects include messages or pretty objects embedded in the candle or stuck to or placed inside a container for the candle. However, none of the message candles are easy to make or easily customizable. A candle that contains an easily-customizable and concealed message would enhance the use of candles by adding a customized “surprise” element to the warmth that makes them desirable.

### SUMMARY

A candle including a mass of opaque fuel and a wick extending therethrough is disclosed. A printed object is embedded in the mass of opaque fuel, wherein the printed object includes a plastic material having ink disposed thereon to depict an image.

In another aspect, the inventive concept includes a method of making a candle. The method entails providing a mass of opaque fuel, placing a printed object on the mass of opaque fuel, and adding additional mass of opaque fuel on top of the printed object.

In yet another aspect, the inventive concept includes a kit for making a candle with a custom image. The kit includes a container, a first mass of opaque fuel with a wick extending therefrom, a second mass of opaque fuel, and a plastic sheet onto which an image can be printed.

### BRIEF DESCRIPTION OF THE DRAWINGS

FIG. 1 is a perspective view of a candle in accordance with one embodiment of the inventive concept.

FIG. 2 is a top view of the candle pf FOG/1 when the wick is not lit.

FIG. 3 is a top view of the embedded object according to one embodiment of the inventive concept.

FIG. 4 is a top view of the candle when the wick has been lit for some time, in accordance with one embodiment of the inventive concept.

FIG. 5 is a perspective view of the candle in accordance with another embodiment of the inventive concept.

FIG. 6 is a top view of the candle of FIG. 5 at a point in time t1, in accordance with one embodiment.

FIG. 7 is a top view of the candle of FIG. 5 at a point in time t2, in accordance with one embodiment.

FIG. 8 is a perspective view of the candle in accordance with another embodiment.

FIG. 9 is a depiction of a candle-making kit in accordance with another embodiment.

### DETAILED DESCRIPTION

A candle that has a concealed object is disclosed. The candle includes a mass of opaque fuel with a wick extending through it. An object is embedded in the mass such that when the candle is lit and the opaque fuel liquefies to turn clear from the heat, the embedded object becomes visible. The object may be a plastic material with images printed on it; for example, a thin sheet of transparent material with pictures and/or characters printed thereon. The plastic material is heat-resistant such that it does not melt or otherwise deform in response to the heat from the flame. A cellulose acetate sheet that is used for overhead projection may be suitable. Images and/or characters may be printed on the cellulose acetate sheet using laser printers, copiers, inkjet printers, or any other suitable means for depositing ink on the sheet, making the image/characters easy to customize. The object has a hole in it through which the wick extends into the depth of the mass of opaque fuel.

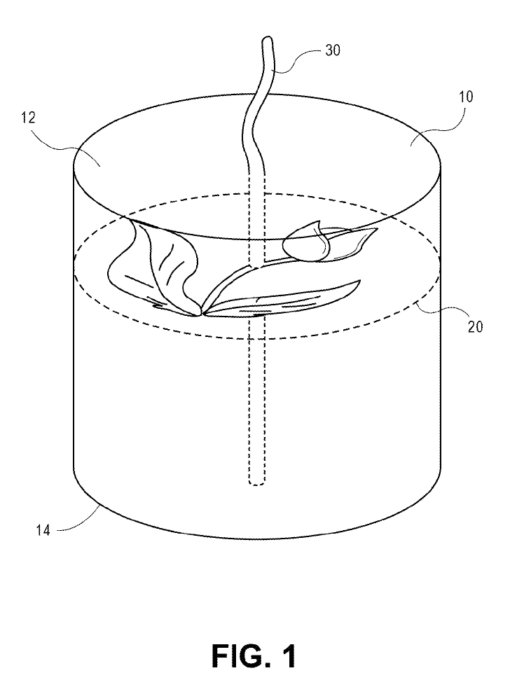

FIG. 1 depicts a perspective view of a candle having a mass of opaque fuel 10 with an embedded object 20 and a wick 30. Due to the opaque nature of the mass 10, the embedded object 20 is not visible when the candle is not lit. “Opaque fuel,” as used herein, is a combustible fuel that is opaque and solid at room temperature but liquefies and turns clear when heated. The opaque fuel may be any material that is commonly used for candles such as wax, paraffin, soy, or combinations thereof. The mass 10 has a top surface 12 and a bottom surface 14.

The embedded object 20 may be a plastic material that can be printed on using laser printers, copiers, inkjet printers, or any other suitable means for depositing ink on a sheet. Transparent, heat-resistant, and flexible cellulose acetate sheets that are commonly used for overhead projection may be suitable, among other materials. For the candle wick 30, any conventional wick material may be used.

In the embodiment of FIG. 1, as the wick 30 remains lit longer and more of the mass 10 liquefies, the liquefaction may happen only a certain distance from the wick 30 such that the portion of the mass 10 that forms the outer wall, which remains closer to room temperature, remains solid. Thus, the liquefied fuel remains contained and does not spill out.

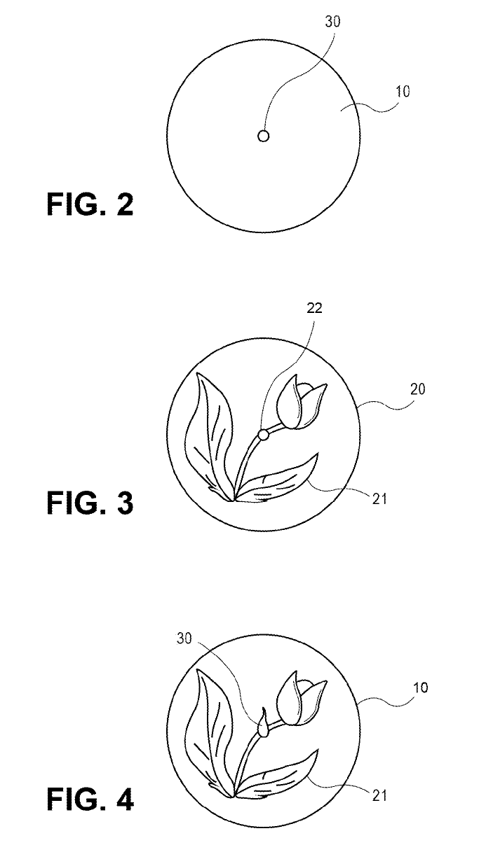

FIG. 2 depicts a top view of the candle when the wick is not lit. All that is viewable is the mass of opaque fuel 10.

FIG. 3 depicts a top view of the embedded object 20, according to one embodiment. As shown, the embedded object 20 has an image 21 printed thereon (a flower, in this particular example) and a hole 22 extending therethrough to accommodate the wick 30.

FIG. 4 depicts a top view of the candle after the wick 30 has been lit for some time. Some time after the wick 30 is lit, the portion of the opaque fuel 10 begins to liquefy in response to the rise in temperature, starting with the area that is closest to the flame. As the liquefaction progresses, an increasing proportion of the opaque fuel 10 turns transparent or clear. Due to the position of the flame at the top of the candle, liquefaction happens from top to bottom. When much of the opaque fuel 10 that is positioned above the embedded object 20 liquefies, the image 21 becomes visible through the fuel 10. “Image,” as used herein, refers to any picture, letter, number, or character depicted by deposition of ink on the embedded object 20.

In one embodiment, the embedded object 20 may be positioned about ¼″ below the top surface 12 of the mass 10. However, this is not a limitation and the embedded object 20 may be deposited at any desired depth. The farther from the top surface 12 the embedded object 20 is positioned, the longer it will take for the image 21 to become visible.

As the candle remains lit for a long time and a larger portion of the mass 10 liquefies, the embedded object 20 migrates downward, toward the bottom surface 14. To effectively achieve this effect, the embedded object 20 may be selected to have a density that is higher than the liquefied opaque fuel. Furthermore, the embedded object 20 should be sized and/or shaped to allow the liquefied fuel under it to travel upward above the embedded object. Although candles with circular horizontal cross sections are depicted here, the inventive concept is not limited to candles of any particular shape or size. The embedded object 20 may be shaped and sized to achieve the desired appearance when the mass 10 liquefies; for example, the embedded object 20 may have an outline that is substantially the same shape as the horizontal cross section of the mass 10. A “horizontal” cross section is the shape of the surface that would become exposed if the mass 10 is sliced in a plane parallel to the bottom surface 14.

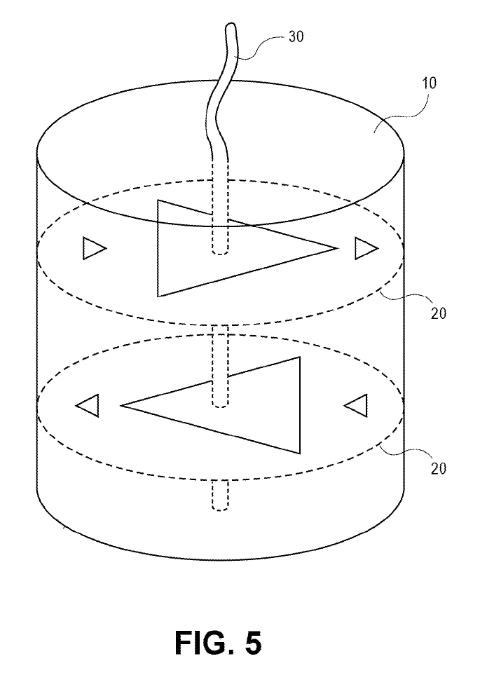

FIG. 5 depicts the candle in accordance with another embodiment. This embodiment is similar to the embodiment of FIG. 1 except there are a plurality of embedded objects 20 spaced apart from each other. This type of embodiment that includes a plurality of embedded objects 20 take advantage of the downward migration of the embedded object 20 to create an evolving image.

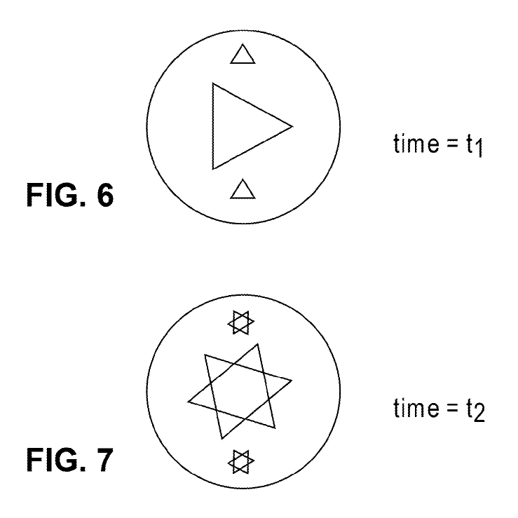

FIG. 6 depicts a top view of the candle of FIG. 5 at a point in time t1, which represents a certain amount of passage of time after the wick 30 has been lit. At time t1, the mass that is above the first embedded object 20 is liquefied but the mass 10 below the embedded object 20 is still mostly solid. Hence, only the first embedded object 20 is visible. As the wick 30 remains lit longer, more of the mass 10 liquefies and the first embedded object 20 migrates downward, toward the second embedded object 20. As this migration occurs, the image that is viewed by a user evolves. In the particular example, the image evolves from triangles to stars because the images 21 printed on the two embedded objects 20, when superimposed, form stars. FIG. 7 depicts a top view of the candle of FIG. 5 at a point in time t2, which is when the first embedded object 20 has sunken close enough to the second embedded object 20 that the two images 21 are superimposed and the image evolution is complete.

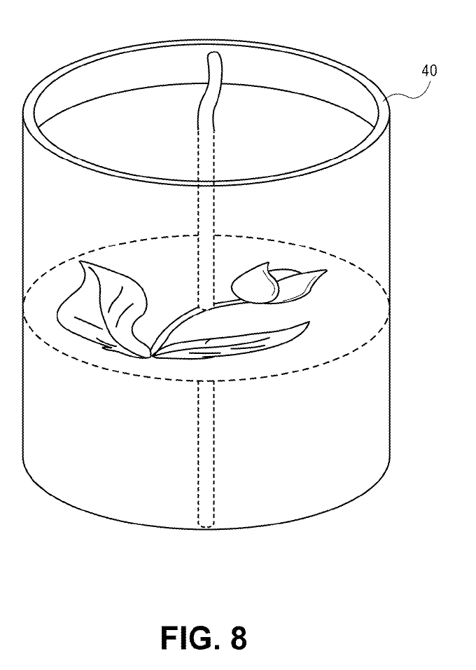

FIG. 8 depicts the candle in accordance with another embodiment. The candle of FIG. 8 is similar to the candle of FIG. 1 and FIG. 5, with a container 40 added. The container 40 may be made of any solid, heat-resistant material, and may be opaque or transparent. The mass 10 fills part of the container 40.

While the embodiments are described in terms of an article of manufacture, the inventive concept extends to the method and technique for making the disclosed article of manufacture. The candle of the inventive concept may be made according to any known candle-making process, with the additional step of placing an embedded object 20 in the mass 10. This may be done, for example, by providing a first mass of opaque fuel, disposing or positioning the embedded object 20 on the first mass, and disposing a second mass of opaque fuel on the embedded object 20.

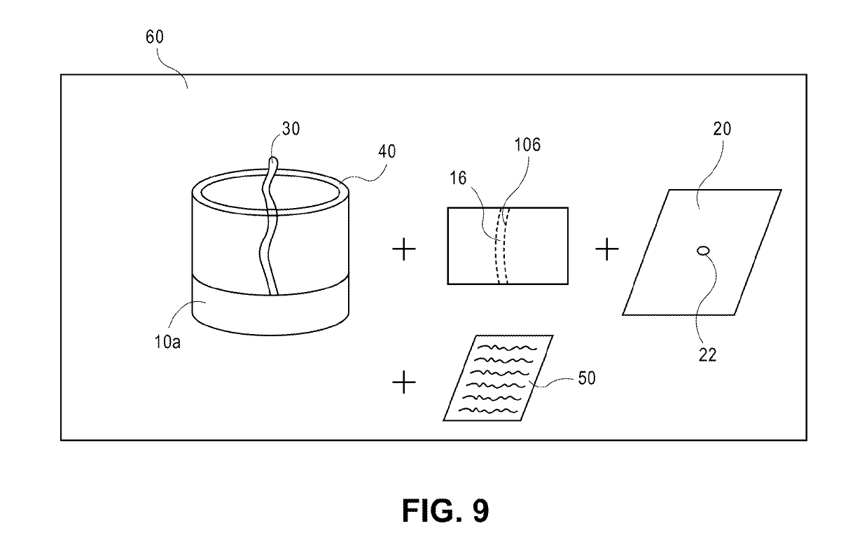

The candle of the inventive concept may also be packaged and marketed as a kit. FIG. 9 depicts a custom candle kit 60 in accordance with one embodiment. The candle kit 60 includes the container 40, a first mass of the opaque fuel 10a, a second mass of the opaque fuel 10b, and one or more sheets of a transparent printable plastic material 20 with at least one hole 22 formed therethrough. The plastic material 20 may be sized for a standard home printer, for example 8.5″×11″. The first mass of the opaque fuel 10a may be placed at the bottom of the container 40 with the wick 30 extending therefrom. The kit 60 also includes an instruction 50 for the user to print an image of choice on the plastic material, cut out the printed image, place it on the first mass 10a while making sure the wick 30 extends through the hole 22, add the second mass 10b on top of the plastic material sheet 20 with the wick 30 extending through a hole 16, and apply heat to the combined mass. The use of plastic material sheet 20 on which many consumers can print at home allows this customizable candle kit 60 to be user-friendly. All the above components of the kit may be packaged in a bag or a box.

It should be understood that the inventive concept can be practiced with modification and alteration within the spirit and scope of the appended claims. The description is not intended to be exhaustive or to limit the inventive concept to the precise form disclosed. It should be understood that the inventive concept can be practiced with modification and alteration.

What is claimed is:

1. A candle comprising:
a mass of opaque fuel;
a printed object embedded in the mass of opaque fuel, wherein the printed object includes a plastic material having ink disposed thereon; and
a wick extending through the mass of opaque fuel.

2. The candle of claim 1, wherein the plastic material is a plastic sheet.

3. The candle of claim 1, wherein the plastic material comprises cellulose acetate.

4. The candle of claim 1, wherein the printed object is a cellulose acetate sheet with images printed thereon.

5. The candle of claim 1, wherein the printed object has an outline in a shape that matches a shape of a horizontal cross section of the mass of opaque fuel.

6. The candle of claim 1, wherein the printed object has a circular shape.

7. The candle of claim 1, wherein the printed object is a plastic sheet positioned substantially parallel to a bottom surface of the mass of opaque fuel.

8. The candle of claim 1, wherein the printed object has a hole through which the wick extends.

9. The candle of claim 1 further comprising a container holding the mass of opaque fuel.

10. The candle of claim 1, wherein the printed object moves through the mass of opaque fuel with increasing duration that the wick remains lit.

11. The candle of claim 10, wherein the printed object moves toward a bottom of the mass of opaque fuel with increasing duration that the wick remains lit.

12. The candle of claim 1, wherein the printed object is a first embedded object, further comprising a second embedded object disposed in the mass of opaque fuel spaced apart from the first embedded object.

13. A method of making a candle, comprising:
providing a mass of opaque fuel;
placing a printed object on the mass of opaque fuel; and
adding additional mass of opaque fuel on top of the printed object.

14. A candle-making kit, comprising:
a container;
a first mass of opaque fuel with a wick extending therefrom;
a second mass of opaque fuel; and
a plastic sheet sized for a standard printer.
